(19) United States
(12) Patent Application Publication
(10) Pub. No.: US 2004/0138399 A1
(43) Pub. Date: Jul. 15, 2004

(54) Preparation of silicone resins

(76) Inventors: Iain Alasdair MacKinnon, Penarth (GB); Pierre Maurice Chevalier, Penarth (GB); Duan Li Ou, Framingham, MA (US)

Correspondence Address: McKellar Stevens, Poseyville Professional Complex, 784 South Poseyville Road, Midland, MI, 48640, US

(21) Appl. No.: 10/473,453

(22) PCT Filed: Mar. 22, 2002
(86) PCT No.: PCT/EP02/04197

(30) Foreign Application Priority Data
Apr. 3, 2001 (GB) 01082742

(51) Int. Cl. C08G 77/12

(52) U.S. Cl. 528/31

(57) ABSTRACT

In a process for the preparation of a solution of a stable silicone resin comprising SiO_{4/2} units and units selected from RSiO_{3/2}, RR′SiO_{2/2}, and RR′₂SiO_{1/2} units, where R is an alkyl, alkenyl, substituted alkyl, cycloalkyl, aryl or aralkyl group imparting desired physical or chemical properties to the resin, for example a thermally labile group, and each R′ is a different alkyl, substituted alkyl, cycloalkyl, aryl or aralkyl group, or a hydrogen atom, a hydrosiloxane resin comprising HSiO_{3/2} units and the said units selected from RSiO_{3/2}, RR′SiO_{2/2}, and RR′₂SiO_{1/2} units is treated with a base to condense at least some of the HSiO_{3/2} units to form SiO_{4/2} units. The base is preferably a solution of an alkali metal salt of a weak acid, such as sodium acetate.

### FIELD OF THE INVENTION

This invention relates to a process for the preparation of silicone resins containing alkyl, substituted alkyl or cycloalkyl groups imparting desired physical or chemical properties to the resin, and to the resins prepared thereby.

Preferred examples of alkyl, substituted alkyl or cycloalkyl groups imparting desired physical or chemical properties to the resin are thermally labile groups whereby the resin thermally degrades to a nanoporous resin. According to one aspect, the invention thus relates to a method for making nanoporous silicone resins, including substrates coated with nanoporous silicone resins, from the silicone resins having thermally labile groups. The resulting nanoporous silicone resins have low dielectric constant and improved mechanical properties and are useful as insulating films in semiconductor devices.

Alternative examples of alkyl, substituted alkyl or cycloalkyl groups imparting desired physical or chemical properties to the resin are groups imparting optical properties such as unusually high or low refractive index or anisotropy, groups giving hydrophobic, oleophobic or hydrophilic properties or groups intended to react with a target chemical or biochemical material.

### BACKGROUND TO THE INVENTION

WO-A-98/49721 describes a process for forming a nanoporous dielectric coating on a substrate. The process comprises the steps of blending an alkoxysilane with a solvent composition and optional water; depositing the mixture onto a substrate while evaporating at least a portion of the solvent; placing the substrate in a sealed chamber and evacuating the chamber to a pressure below atmospheric pressure; exposing the substrate to water vapour at a pressure below atmospheric pressure and then exposing the substrate to base vapour.

JP-A-10-287746 teaches the preparation of porous films from siloxane-based resins having organic substituents which are oxidized at a temperature of 250° C. or higher. The useful organic substituents which can be oxidized at a temperature of 250° C. or higher given in this document include substituted and unsubstituted groups as exemplified by 3,3,3-trifluoropropyl, β-phenethyl group, t-butyl group, 2-cyanoethyl group, benzyl group and vinyl group.

Mikoshiba et al., J. Mat. Chem., 1999, 9, 591-598, report a method to fabricate angstrom size pores in poly(methylsilsesquioxane)films in order to decrease the density and the dielectric constant of the films. Copolymers bearing methyl(trisiloxysilyl) units and alkyl(trisiloxysilyl) units are spin-coated on to a substrate and heated at 250° C. to provide rigid siloxane matrices. The films are then heated at 450° C. to 500° C. to remove thermally labile groups and holes are left corresponding to the size of the substituents. Trifluoropropyl, cyanoethyl, phenylethyl, and propyl groups were investigated as the thermally labile substituents.

WO-A-98/47945 teaches a method for reacting trichlorosilane and organotrichlorosilane to form organohydridosiloxane polymers having a cage conformation and between approximately 0.1 to 40 mole percent carbon-containing substituents. Resins formed from the polymers are reported to have a dielectric constant of less than 3. WO-A-98/47941, WO-A-98/47942 and WO98-A-47944 have similar disclosures, and WO-A-00/75975 and WO-A-00/75979 prepare siloxane resins by a similar process.

JP-A-7-102215 describes reacting a hydrogen silsesquioxane polymer with a dialkoxysilane in the presence of a base to form a coating material with reduced occurrence of cracking.

### SUMMARY OF THE INVENTION

A process according to the present invention for the preparation of a silicone resin comprising SiO_{4/2} units (also known as Q units) and units selected from RSiO_{3/2} (also known as T units), RR′SiO_{2/2}, and RR′₂SiO_{1/2} units, where R is an alkyl, alkenyl, substituted alkyl, cycloalkyl, aryl or aralkyl group imparting desired physical or chemical properties to the resin and each R′ is a different alkyl, substituted alkyl, cycloalkyl, aryl or aralkyl group, or a hydrogen atom, is characterised in that a hydrosiloxane resin comprising HSiO_{3/2} units and the said units selected from RSiO_{3/2}, RR′SiO_{2/2}, and RR′₂SiO_{1/2} units is treated with a base to condense at least some of the HSiO_{3/2} units to form SiO_{4/2} units.

### DETAILED DESCRIPTION OF THE INVENTION

The group R is preferably a thermally labile group but alternatively can be a group imparting optical properties such as unusually high or low refractive index or anisotropy, a group giving hydrophobic, oleophobic or hydrophilic properties or a group intended to react with a target chemical or biochemical material.

A thermally labile group R is generally selected from alkyl, substituted alkyl and cycloalkyl groups containing at least 3 carbon atoms up to about 30 carbon atoms, preferably 4 to 20 carbon atoms. A preferred thermally labile group R is a branched alkyl group. We have found that the presence of branched alkyl groups in the silicone resin leads to nanoporous resins of improved strength after controlled thermal degradation. One preferred example of a branched alkyl group R is t-butyl —C(CH3)3, which is thermally labile by interaction of the beta-carbon groups present in t-butyl and the Si—C linkage as part of the overall thermal degradation. Alkyl, substituted alkyl and cycloalkyl groups having at least one aliphatic beta-carbon atom bearing H atoms are preferred groups R because of the possibility of this type of thermal degradation. Further examples of preferred branched alkyl groups R include 2-methylpropyl (isobutyl), 2-(2,2-dimethylpropyl)-4,4-dimethylpentyl (colloquially known as triisobutyl), 2,2-dimethylpropyl and 2,4,4-trimethylpentyl (isooctyl).

Other examples of thermally labile groups R are linear alkyl groups such as n-propyl, hexyl, nonyl, octyl decyl, dodecyl, hexadecyl or octadecyl. Long chain alkyl groups, for example those having 8 to 20 carbon atoms may be preferred as they lead to nanoporous resins after thermal degradation which have improved porosity and potentially lower dielectric constant.

The hydrosiloxane resin can advantageously include units in which R is a branched alkyl group, for example a t-butyl group, and also units in which R is a hydrocarbon group comprising 8 to 24 carbon atoms or a substituted hydrocarbon group comprising a hydrocarbon chain having 8 to 24 carbon atoms. Silicone resins produced by controlled thermal degradation of such hydrosiloxane resins are nanoporous resins having an optimum combination of strength, porosity and low dielectric constant.

Further examples of thermally labile groups R are substituted alkyl groups such as 3,3,3-trifluoropropyl, trimethylsiloxyoctyl, methoxyoctyl, ethoxyoctyl, trimethylsiloxyhexadecyl or chlorooctyl, and cycloalkyl groups such as cyclopentyl.

Examples of groups imparting optical properties are groups of the formula —(A)n—(Ar)m where A represents an alkylene group having 1 to 4 carbon atoms: n=0 or 1; m is at least 1; and Ar is an aryl group substituted by at least one iodine, bromine or chlorine atom, or is a polynuclear aromatic group, which form resins having an unusually high refractive index. The group R can for example be iodophenyl, diiodophenyl, bromophenyl, dibromophenyl, chlorophenyl, dichlorophenyl or trichlorophenyl, or an optionally substituted naphthyl, anthracenyl, phenanthrenyl or pyrenyl group, or an optionally substituted biphenyl group, or iodonaphthyl, chloronaphthyl, bromonaphthyl or (iodophenyl)phenyl.

One example of a reactive group intended to react with a target chemical material is an alkenyl group, particularly an alkenyl group having 1 to 6 carbon atoms. The alkenyl group is preferably vinyl although allyl or hexenyl are alternatives. Siloxane units RR′₂SiO_{1/2} can for example be vinyldimethylsiloxy or vinylmethylphenylsiloxy units. Resins containing such an alkenyl group can for example be reacted with a curing agent containing Si—H groups in the presence of a catalyst containing a platinum group metal. Such a reaction may form a cured heat resistant silicone resin having a low coefficient of thermal expansion. The curing agent can for example be a polysiloxane containing at least two Si—H groups, for example HMe2Si—(O—SiMe2)4—O—SiMe2H (M^{H}D₄M^{H}) or a polymethylhydrogensiloxane such as 1,3,5,7-tetramethylcyclotetrasiloxane (D^{H,Me}₄), or a silicone resin containing HMe2Si— groups such as (HMe2SiO1/2)8(SiO4/2)8 (M^{H}₈Q₈), or an organic compound containing SiH groups such as 1,4-bis(dimethylsilyl)benzene. Siloxane resins containing vinyldimethylsiloxy or vinylmethylphenylsiloxy units together with HSiO3 units and Q units are self-curable on heating in the presence of a catalyst containing a platinum group metal.

The process of the invention is particularly useful for producing resins comprising SiO_{4/2} units and RSiO_{3/2} units from a hydrosiloxane T resin comprising RSiO_{3/2} units and HSiO_{3/2} units. Such a hydrosiloxane T resin can be prepared by reaction of an organochlorosilane of the formula RSiCl3 with trichlorosilane HSiCl3, and generally comprises 10-90, preferably 15-85, mole % RSiO_{3/2} units and 10-90, preferably 20-80, mole % HSiO_{3/2} units (T^{H} units).

The hydrosiloxane resin can alternatively contain RR′SiO_{2/2} (D units) and/or RR′₂SiO_{1/2} (M units) in addition to HSiO_{3/2} units and optionally RSiO_{3/2} units. Examples of valuable resins containing M units are those where R is an alkenyl group, for example resins containing vinyldimethyl M units, which can be reacted with base to form a curable MQ or MTQ resin.

The hydrosiloxane T resin may additionally contain R′SiO3/2 units in which R′ is an unreactive and thermally stable organic group, for example methyl or phenyl, at 0-50 mole % of the resin. The R′SiO3/2 units can be produced by co-reaction of an organochlorosilane of the formula R′SiCl3. Unreactive R′₂SiO_{2/2} or R′₃SiO_{1/2} units can also be present, for example dimethylsiloxy or trimethylsiloxy units, although this is generally not preferred.

The hydrosiloxane resin may additionally contain SiO4/2 units (Q units), which can be formed for example by pre-hydrolysis-condensation of the HSiO3/2 units during the hydrosiloxane resin synthesis, although this is not preferred.

The hydrosiloxane resin is treated with a base to condense (hydrolyse and condense) at least some of the HSiO3/2 units to form SiO4/2 units. One preferred base is a solution of an alkali metal salt of a weak acid such as a carboxylic acid, for example sodium acetate, sodium hydrogen phosphate or sodium tetraborate. An aqueous and/or organic solvent solution can be used. A preferred solvent mixture comprises water and a dipolar aprotic solvent which is at least partially miscible with water. The dipolar aprotic solvent can for example be a ketone having 4 to 7 carbon atoms such as methyl isobutyl ketone (MIBK), methyl ethyl ketone or methyl isoamyl ketone, or can be a cyclic ether such as tetrahydrofuran or dioxane. Alternatively the base may comprise an amine, preferably a tertiary amine, particularly a trialkyl amine such as triethylamine or tripropylamine, or alternatively pyridine or dimethylaminopropanol. The base can for example be an aqueous solution of triethylamine. A tertiary amine can act as both base and as a dipolar aprotic solvent, so that one base reagent comprises a solution of an alkali metal salt of a weak acid in a solvent mixture of water and a tertiary amine.

The degree of conversion of HSiO_{3/2} units to SiO_{4/2} units can be controlled by controlling the strength and concentration of the base used to treat the resin, the time of contact between the resin and the base and the temperature of the reaction, so that resins of given SiO_{4/2} content can be prepared reproducibly with the resin remaining in solution. The base strength and concentration and time and temperature of treatment are preferably sufficient to condense at least 30% of the HSiO_{3/2} units to SiO_{4/2} units. In some cases 100% conversion may be desired; in other cases a lower level, for example 40-80% conversion, may be preferred. For example, a 0.5M sodium acetate solution in aqueous MIBK will cause 50% conversion of HSiO_{3/2} units to SiO_{4/2} units at 100-110° C. in about 1 hour. A 0.5M solution of sodium acetate in aqueous triethylamine will cause 50% conversion at 25° C. in about 30-40 minutes. 100% conversion can be achieved by using the latter solution at 70° C. for a few hours.

Because the process of the invention can produce TTQ resins from only two reagents RSiCl3 and HSiCl3, it can produce TTQ resins of better homogeneity and increased stability than processes which require SiCl4 as a third reagent to introduce Q groups. The conversion of T^{H} units into Q units is believed to increase the stability of the silicone resin solution and also to increase the rigidity of the silica framework. The increased stability gives access to a wider composition range. The process of the invention can be used to form a curable resin in which at least 5 mol %, preferably at least 20 or 30%, up to 50 or 55 mol % of the siloxane units of the resin are SiO4/2 units. Resins having over 20% Q units can not easily be prepared directly from SiCl4 or a tetraalkoxysilane without precipitation of silica. For resins containing thermally labile groups R, the conversion of T^{H} units into Q units minimises any collapsing effect of the pore structure during the thermal curing process. The thermally labile TTQ resins produced by the present invention lead to highly nanoporous materials which can have a modulus over 4 GPa and up to 8 GPa after pyrolysis.

To form a nanoporous silicone resin, the thermally labile silicone resin is heated at a temperature sufficient to effect curing of the silicone resin and thermolysis of R groups from silicon atoms. Generally the resin is heated at a temperature of greater than 150° C. and usually greater than 350° C. Usually, the resin is coated on a substrate and the coated substrate is heated to effect thermolysis, thereby forming a nanoporous silicone resin coating on the substrate. The resin is preferably coated on the substrate from solution in an organic solvent. Such a coating solution may be the purified resin solution reaction product as described above, or the isolated resin can be dissolved in an organic solvent, for example an aromatic hydrocarbon such as toluene, xylene or mesitylene, a ketone such as MIBK, or an ester such as butyl acetate or isobutyl isobutyrate. The concentration of silicone resin in the organic solvent is not particularly critical to the present invention and is any concentration at which the silicone resin is soluble and which provides for acceptable flow properties for the solution in the coating process. Generally, a concentration of silicone resin in the organic solvent of 10 to 25 weight percent is preferred. The silicone resin is coated on the substrate by standard processes for forming coatings on electronic components such as spin coating, flow coating, dip coating and spray coating.

The substrate having the silicone resin coating is heated in preferably an inert atmosphere at a temperature sufficient to effect curing of the silicone resin coating and thermolysis of R groups from silicon atoms. The heating may be conducted as a single-step process or as a two-step process. In the two-step process the silicone resin is first heated in preferably an inert atmosphere at a temperature sufficient to effect curing without significant thermolysis of R groups from silicon atoms. Generally, this temperature is from 20° C. to 350° C. Then, the cured silicone resin is further heated at a higher temperature which is greater than 150° C. and preferably greater than 350° C. to effect thermolysis. In the single-step process, the curing of the silicone resin and thermolysis of R groups from silicon atoms are effected simultaneously by heating the substrate having the silicone resin to a temperature of greater than 150° C. Thermolysis is preferably conducted at a temperature of 350° C. to 600° C., with a temperature of 400° C. to 550° C. being most preferred, although there is also significant pore formation at lower temperatures such as 200 to 300° C. The inert atmosphere can be any of those known in the art, for example, argon, helium or nitrogen.

The nanoporous silicone resin produced has pores less than 20 nm in diameter and usually less than about 5 nm diameter, for example the nanoporous coating typically has a pore diameter in the region of 0.3 nm to 2 nm. The nanoporous silicone resins are particularly useful as low dielectric constant films on electronic devices such as integrated chips. The nanoporous silicone resin coatings prepared by the present method generally have a dielectric constant dk of from 1.7 (n-octadecyl resin) to 2.5 (t-butyl resin) and modulus from 1.3 (n-octadecyl resin) to over 4 and up to 8 GPa (t-butyl resin).

The nanoporous silicone resins can also be made in particulate form, for example by spray drying the purified resin solution and heating to effect thermolysis as described above. The particulate nanoporous silicone resins can be used in known applications where porous materials are used, for example as packing in chromatography columns.

The following examples are provided to illustrate the present invention.

### EXAMPLE 1

t-BuSiCl₃ (10.9 g, 57 mmol), HSiCl₃ (7.7 g, 57 mmol), and THF (100 ml) were charged to a three-necked flask which had been flushed with N₂; the flask was equipped with a condenser/inert gas inlet, magnetic stirrer, and pressure-equalised dropping funnel. Distilled water (9.23 g, 513 mmol) and THF (40 ml) were charged to the dropping funnel. The chlorosilane solution was cooled to 0 to 5° C. in an ice/water bath; the water/THF solution was added over 30 mins. The cooling bath was removed and the reaction mixture was stirred for a further 1 h at ambient temperature. Volatiles were removed under reduced pressure (100 mbar/30° C.) to give thick oily droplets. All the slurry was extracted into toluene (100 ml) and washed to neutral with distilled water (5×100 ml). The resulting suspension was dried over anhydrous Na₂SO₄; after filtering, a clear, colourless solution was obtained. All volatiles were removed under reduced pressure (100 mbar/30° C., then 1 mbar/ambient temperature≈20° C.) to give 8.0 g of a crispy white solid which was a T^{tBu}_{0.5}T^{H}_{0.5} copolymer (hydrosiloxane resin).

5 g of T^{tBu}_{0.5}T^{H}_{0.5} copolymer were dissolved in 25 ml MIBK and mixed with 25 ml 1M NaAc (sodium acetate) aqueous solution. The mixture was refluxed at 110° C. for 1 hr. The organic phase were washed, dried and stripped to obtain T^{tBu}_{0.50}T^{H}_{0.24}Q_{0.26} copolymer (51.2% T^{H} conversion).

### EXAMPLE 2

5 g of T^{tBu}_{0.5}T^{H}_{0.5} copolymer were dissolved in 25 ml MIBK and mixed with 25 ml 1M NaAc aqueous solution. The mixture was refluxed at 110° C. for 0.5 hr, then worked up as Example 1 to give T^{tBu}_{0.50}T^{H}_{0.28}Q_{0.22} copolymer (43.2% T^{H} conversion).

### EXAMPLE 3

5 g of T^{tBu}_{0.5}T^{H}_{0.5} copolymer were dissolved in 25 ml Et₃N and mixed with 25 ml 1M NaAc aqueous solution at 0° C. for 1 hr, then worked up as Example 1 to give T^{tBu}_{0.05}T^{H}_{0.20}Q_{0.30} copolymer (59.6% T^{H} conversion).

### EXAMPLE 4

5 g of T^{tBu}_{0.5}T^{H}_{0.5} copolymer were dissolved in 25 ml Et₃N and mixed with 25 ml 1M NaAc aqueous solution at 25° C. for 1 hr, then worked up as Example 1 to give T^{tBu}_{0.50}T^{H}_{0.16}Q_{0.34} copolymer (68.4% T^{H} conversion).

### EXAMPLE 5

5 g of T^{tBu}_{0.5}T^{H}_{0.5} copolymer were dissolved in 25 ml Et₃N and mixed with 25 ml 1M NaAc aqueous solution at 70° C. for 12 hr, then worked up as Example 1 to give T^{tBu}_{0.50}Q_{0.50} copolymer (100% T^{H} conversion).

### EXAMPLE 6

5 g of T^{tBu}_{0.5}T^{H}_{0.5} copolymer were dissolved in 25 ml Et₃N and mixed with 25 ml 1M NaAc aqueous solution at 70° C. for 12 hr, then worked up as Example 1 to give T^{tBu}_{0.5}Q_{0.5} copolymer (100% T^{H} conversion).

The TTQ copolymer resins produced in Examples 1-6, and also the T^{tBu}_{0.5}T^{H}_{0.5} copolymer used as starting material, were pyrolysed at 450° C. under an inert atmosphere and the porosity of the pyrolysed copolymer resins was measured using the nitrogen sorption method on a Quantachrome Autosorb 1MP instrument. The results are collated in Table 1. The introduction of Q species into T^{tBu}_{0.5}T^{H}_{0.5} copolymer leads to a substantial increase of porosity after pyrolysis, although the increment on porosity was not proportional to the amount of Q species converted from T^{H}.

TABLE 1

| | | BET surface | Total pore |
|---|---|---|---|
| | % T^{H} to Q conversion | area (m²/g) | volume (cc/g) |
| T^{tBu}_{0.5}T^{H}_{0.5} | 0 | 424 | 0.263 |
| Example 2 | 43.2 | 528 | 0.358 |
| Example 1 | 51.2 | 463 | 0.325 |
| Example 4 | 68.4 | 496 | 0.312 |
| Example 5 | 96.0 | 490 | 0.295 |
| Example 6 | 100 | 561 | 0.366 |

The pore size distribution was calculated by the BJH method (E. P. Barrett, L. G. Joyner and P. D. Halenda, J. Am. Chem. Soc. 1952, 73, 373). The pore size distribution of the resins of Examples 1 to 6 were similar to their precursor T^{tBu}_{0.5}T^{H}_{0.5}, with no pores bigger than 5 nm present in these materials.

Samples of the TTQ copolymer resin of Example 1 were pyrolysed at different temperatures in the range 150 to 600° C. In each case the resin was heated at 5° C./min then held at the stated temperature for 2 hours. The results are shown in Table 2 below

TABLE 2

| Temperature ° C. | Total pore volume |
|---|---|
| 150 | 0.29 |
| 250 | 0.33 |
| 450 | 0.32 |
| 600 | 0.25 |

Thin Film Properties of the TTQ resins were measured to evaluate their suitability for interlayer dielectric applications. The T^{tBu}T^{H}Q copolymer resins of Examples 1 to 6, and also the T^{tBu}_{0.5}T^{H}_{0.5} copolymer used as starting material, were each dissolved at about 20% in MIBK, spin-coated onto silicon wafers and pyrolysed at 450° C. under inert atmosphere. The thickness, refractive index, dielectric constant (dk), modulus and hardness of the nanoporous silicone resin coatings produced were measured. Modulus and hardness values were measured using a Hysitron Triboscope nanomechanical testing instrument. A Berkovich diamond indenter was used for all measurements. Hardness and reduced modulus values were determined at a penetration depth of ˜15%. The reduced modulus (E_{R}=E/(1−□²), where E and □ are the Young's modulus and Poisson's ratio respectively, was determined from the slope of the unloading curve. The values reported were the average of three indents measured at different areas of the film. The results are summarised in Table 3.

TABLE 3

| | % T^{H} | Film Thickness | Refractive | DK | Modulus | Hardness |
|---|---|---|---|---|---|---|
| | conversion | (nm) | Index | 10⁶ Hz | (GPa) | (GPa) |
| T^{tBu}_{0.5}T^{H}_{0.5} | 0 | 554 | 1.301 | 2.36 | 5.3 | 0.69 |
| Example 2 | 43.2 | 603 | 1.291 | 2.35 | / | / |
| Example 1 | 51.2 | 662 | 1.314 | 2.37 | 5.4 | 0.81 |
| Example 4 | 68.4 | 710 | 1.304 | 2.30 | 4.0 | 0.60 |
| Example 5 | 96.0 | 718 | 1.314 | 2.49 | 4.6 | 0.67 |
| Example 6 | 100 | 657 | 1.334 | 2.72 | 7.1 | 1.29 |

The thickness of these films was in the range between 550 nm to 720 nm, with deviation less than 4%. Good quality, crack-free thin films were formed from the TTQ copolymers. The dielectric constant (dk) of these resin films is low and mainly in the range of 2.30 to 2.50. These films exhibit a high modulus between 4 to 7.1 GPa.

### EXAMPLES 7 to 10

45 g of C18H37SiCl₃ (where C18H37 is n-octadecyl) and 47.16 g of HSiCl₃ were mixed into 120 ml MIBK and added dropwise into a mixture of 180 ml 0.5M HCl/H₂O solution, 240 ml MIBK and 120 ml Toluene over 40 minutes at room temperature and were stirred constantly for another hour. (The temperature of the reaction mixture rose to 65-70° C. upon addition). The organic layer was separated and washed four times with distilled water until neutral. A first portion (90 ml) of the resulting T^{C18}T^{H} resin (which also contained some Q groups) was sampled from the solution. Removal of residual water and stripping of the solvent led to 9.3 g of a sticky white solid.

The rest of the T^{C18}T^{H} solution was refluxed with 120 ml of 0.1M aqueous sodium acetate (NaAc) solution at 120° C. Different compositions of T^{C18}T^{H}Q were then sampled (90 ml each) out of the organic layer from the solution system at different times as shown in Table 4 below. After washing the samples four times, stripping off the residual water and solvent, approximately 9 to 10 g. of a white solid were obtained from each of these portions.

### EXAMPLES 11 to 13

A further sample of T^{C18}T^{H} solution, prepared as described in Example 7, was refluxed with 0.55M aqueous sodium acetate solution at 120° C. 90 ml T^{C18}T^{H}Q resin solution samples were withdrawn at different times and the resin was isolated as described in Example 7, the compositions being shown in Table 4.

TABLE 4

| | NaAc concn. | Reaction | % of T^{H} | Formula |
|---|---|---|---|---|
| | (M) | time | conversion | (by ²⁹Si NMR) |
| T^{C18}T^{H} | 0.1 | 0 hr | 20.3 | T^{C18}_{0.23}T^{H}_{0.59}Q_{0.15} |
| resin | | | | |
| Example 7 | 0.1 | 1 hr | 33.3 | T^{C18}_{0.26}T^{H}_{0.50}Q_{0.25} |
| Example 8 | 0.1 | 1 day | 50.7 | T^{C18}_{0.25}T^{H}_{0.37}Q_{0.38} |
| Example 9 | 0.1 | 4 days | 69.7 | T^{C18}_{0.24}T^{H}_{0.23}Q_{0.53} |
| Example 10 | 0.1 | 11 days | 80.7 | T^{C18}_{0.25}T^{H}_{0.15}Q_{0.61} |
| Example 11 | 0.55 | 8 hr | 61.5 | T^{C18}_{0.22}T^{H}_{0.30}Q_{0.48} |
| Example 12 | 0.55 | 24 hr | 68.9 | T^{C18}_{0.27}T^{H}_{0.23}Q_{0.51} |
| Example 13 | 0.55 | 4 days | 85.3 | T^{C18}_{0.21}T^{H}_{0.12}Q_{0.67} |

The TTQ copolymer resins produced in Examples 7-13, and also the T^{C18}T^{H} resin used as starting material, were pyrolysed at 450° C. under an inert atmosphere and the porosity of the pyrolysed copolymer resins was measured as shown in Table 5

TABLE 5

| | BET surface | Total Pore |
|---|---|---|
| | area (m²/g) | volume (cc/g) |
| T^{C18}T^{H} resin | 780 | 0.490 |
| Example 7 | 904 | 0.577 |
| Example 8 | 992 | 0.606 |
| Example 9 | 969 | 0.597 |
| Example 10 | 697 | 0.446 |
| Example 11 | 1016 | 0.634 |
| Example 12 | 954 | 0.579 |
| Example 13 | 894 | 0.540 |

The total pore volume of each of the pyrolysed T^{C18}T^{H}Q resin samples is significantly higher than those of the T^{tBu}H^{Q} copolymers of Examples 1 to 6.

The BJH pore size distribution of the T^{C18}_{0.22}T^{H}_{0.30}Q_{0.48} pyrolysed resin of Example 11 was calculated. A majority of the pores are smaller than 2 nm, and no pores are bigger than 5 nm.

The T^{C18}T^{H}Q copolymer resins of Examples 7 to 13, and also the T^{C18}T^{H} copolymer used as starting material, were each coated onto silicon wafers and pyrolysed as described in Example 1. Thin Film Properties of the TTQ resins were measured as described above and the results are summarised in Table 6.

TABLE 6

| | Thickness | Refractive | | Modulus | Hardness |
|---|---|---|---|---|---|
| | (nm) | Index | dK | (GPa) | (GPa) |
| T^{C18}T^{H} resin | 828 | 1.217 | 2.15 | 1.7 | 0.34 |
| Example 7 | 1016 | 1.211 | 1.80 | 1.5 | 0.26 |
| Example 8 | 998 | 1.196 | 1.87 | 1.3 | 0.21 |
| Example 9 | 1068 | 1.186 | 1.82 | 1.3 | 0.19 |
| Example 10 | 919 | 1.181 | 1.83 | 1.1 | 0.16 |
| Example 11 | 974 | 1.193 | 1.79 | 1.6 | 0.20 |
| Example 12 | 513 | 1.218 | 2.10 | 2.2 | 0.26 |
| Example 13 | 1065 | 1.175 | 1.83 | 1.6 | 0.20 |

The thickness of the films of Examples 7 to 13 was in the 500 nm to 1100 nm range, with a deviation below 4%. Good quality, crack-free thin films were produced. The dielectric constants (dk) are ultra low, mainly in the range of 1.79 to 1.87, and are thus highly suitable for interlayer dielectric use. The modulus was between 1.1 and 2.2 GPa.

### EXAMPLES 14 to 18

46.94 g of C12H25SiCl₃ (where C12H25 is triisobutyl) and 62.88 g of HSiCl₃ mixed into 160 ml MIBK were added dropwise into a mixture consisting of 240 ml 0.5 M HCl/H₂O solution, 320 ml MIBK and 160 ml Toluene over 40 minutes at room temperature. The temperature of the reaction mixture rose to 65 to 70° C. The mixture was left for another hour under constant stirring. The organic layer was separated and washed four times with water until neutral. A first portion (100 ml) of T^{C12}T^{H} resin was sampled from the solution. Removal of residual water and stripping off the solvent led to 9.2 g of a white solid.

The rest of the T^{C12}T^{H} solution was refluxed with 200 ml of NaAc 0.5M aqueous solution at 120° C. Different compositions of T^{C12}T^{H}Q resin were sampled (100 ml each) out of the organic layer from the solution system at different times as shown in Table 7. After washing the samples four times and stripping off the residual water and solvent, approximately 9 to 10 g of a white solid were obtained from each of these portions.

TABLE 7

| | | % of T^{H} | Formula |
|---|---|---|---|
| | Reaction time | conversion | (by ²⁹Si NMR) |
| T^{C12}T^{H} resin | 0 hr | 0 | T^{C12}_{0.25}T^{H}_{0.75} |
| Example 14 | 1 hr | 44.7 | T^{C12}_{0.24}T^{H}_{0.42}Q_{0.34} |
| Example 15 | 1 day | 70.4 | T^{C12}_{0.24}T^{H}_{0.22}Q_{0.53} |
| Example 16 | 4 days | 79.9 | T^{C12}_{0.25}T^{H}_{0.15}Q_{0.60} |
| Example 17 | 7 days | 82.4 | T^{C12}_{0.28}T^{H}_{0.13}Q_{0.60} |
| Example 18 | 11 days | 86.3 | T^{C12}_{0.27}T^{H}_{0.10}Q_{0.63} |

The TTQ copolymer resins produced in Examples 14-18, and also the T^{C12}T^{H} resin used as starting material, were pyrolysed at 450° C. under an inert atmosphere for 2 hours and the porosity of the pyrolysed copolymer resins was measured as shown in Table 8. In a further experiment, the TTQ resin of Example 15 was pyrolysed under an inert atmosphere at 425° C. for 2 hours.

TABLE 8

| | BET surface | Total Pore |
|---|---|---|
| | area (m²/g) | volume (cc/g) |
| T^{C12}T^{H} resin | 686 | 0.409 |
| Example 14 | 782 | 0.459 |
| Example 15 | 793 | 0.465 |
| Example 15* | 680 | 0.430 |
| Example 16 | 829 | 0.492 |
| Example 17 | 770 | 0.468 |
| Example 18 | 708 | 0.441 |

*cured at 425° C. for 2 hr.

The total pore volume of each of the pyrolysed T^{C12}T^{H}Q resins of Examples 14 to 18 are significantly higher than those of the T^{tBu}T^{H}Q resins of Examples 1 to 6, and just slightly lower than the T^{C18}T^{H}Q copolymers prepared by Examples 7 to 13. The BJH pore size distribution of pyrolysed T^{C12}_{0.24}T^{H}_{0.42}Q_{0.34} resin (Example 14) shows that a majority of the pores are smaller than 2 nm, and no pores are bigger than 5 nm.

The T^{C12}T^{H}Q copolymers of Examples 14 to 18 were spin-coated onto silicon wafers and pyrolysed at 450° C. and the films were evaluated as described in Example 1. The results are shown in Table 9.

TABLE 9

| | Thickness | Refractive | | Modulus | Hardness |
|---|---|---|---|---|---|
| | (nm) | Index | dK | (GPa) | (GPa) |
| T^{C12}T^{H} resin | 631 | 1.260 | 2.09 | 5.5 | 0.72 |
| Example 14 | 696 | 1.238 | 2.20 | 4.6 | 0.58 |
| Example 15 | 943 | 1.225 | 2.00 | 2.7 | 0.35 |
| Example 16 | 940 | 1.219 | 2.09 | 2.6 | 0.33 |
| Example 17 | 841 | 1.217 | 2.49 | / | / |
| Example 18 | 768 | 1.218 | 2.24 | 3.1 | 0.36 |

The thickness of these films is in the 630 nm to 950 nm range, with a deviation below 4%. Good quality, crack free thin films were produced.

### EXAMPLES 19 and 20

25.80 g of C18H37SiCl₃, 29.69 g of tBuSiCl₃ and 30 g of HSiCl₃ mixed into 120 ml MIBK were added dropwise into a mixture consisting of 180 ml 0.5M HCl/H₂O solution, 240 ml MIBK and 180 ml Toluene over 40 minutes at room temperature. The temperature of the reaction mixture rose to 65-70° C. upon addition. The mixture was refluxed for another two hours under constant stirring. The organic layer was separated and washed four times with water until neutral. A first portion (270 ml) of T^{C18}T^{tBu}T^{H} resin (which also contained some Q groups) was sampled from the solution. Removal of residual water and stripping of the solvent led to 24.16 g of a white solid.

The rest of the T^{C18}T^{tBu}T^{H} resin solution was refluxed with 90 ml of NaAc 0.1M aqueous solution at 120° C. Different compositions of T^{C18}T^{tBu}T^{H}Q were then sampled (130 ml each) out of the organic layer from the solution system at different times as summarised in Table 10. After washing the samples four times, stripping off the residual water and solvent, approximately 12 to 13 g of a white solid were obtained from each of these portions.

### EXAMPLE 21

T^{C18}T^{tBu}T^{H} resin solution was prepared as described in Example 19 and was refluxed for 5 minutes in a 0.1M solution of sodium acetate in a solvent comprising 40% MIBK, 50% water and 10% triethylamine. A T^{C18}T^{tBu}T^{H}Q resin was isolated by the procedure described in Example 19.

TABLE 10

| | Reaction | % of T^{H} | Formula |
|---|---|---|---|
| | Time | conversion | (by ²⁹Si and ¹³C NMR) |
| T^{C18}T^{tBu}T^{H} resin | 0 hr | 13.5 | T^{C18}_{0.17}T^{tBu}_{0.31}T^{H}_{0.45}Q_{0.07} |
| Example 19 | 1 day | 35.7 | T^{C18}_{0.15}T^{tBu}_{0.28}T^{H}_{0.36}Q_{0.20} |
| Example 20 | 4 days | 54.0 | T^{C18}_{0.18}T^{tBu}_{0.33}T^{H}_{0.23}Q_{0.27} |
| Example 21 | 5 min | 50.9 | T^{C18}_{0.16}T^{tBu}_{0.27}T^{H}_{0.28}Q_{0.29} |

The resins of Examples 19 to 21 and the T^{C18}T^{tBu}T^{H} starting resin were pyrolysed at 450° C. and porosity measurements were carried out as described in Example 1 on the pyrolysed resins. The results are shown in Table 11.

TABLE 11

| | BET surface | Total Pore |
|---|---|---|
| | area (m²/g) | volume (cc/g) |
| T^{C18}T^{tBu}T^{H} resin | 563 | 0.361 |
| Example 19 | 521 | 0.344 |
| Example 20 | 623 | 0.409 |
| Example 21 | 882 | 0.542 |

The total pore volume of each of the pyrolysed T^{C18}T^{tBu}T^{H}Q resins is higher than those of the pyrolysed T^{tBu}T^{H}Q resins of Examples 1-6, and lower than the pyrolysed T^{C18}T^{H}Q resins of Examples 7-13. The BJH pore size distribution of the T^{C18}_{0.8}T^{tBu}_{0.33}T^{H}_{0.23}Q_{0.27} pyrolysed resin of Example 20 showed that a majority of the pores are smaller than 2 nm, and no pores are bigger than 5 nm.

The T^{C18}T^{tBu}T^{H}Q copolymers of Examples 19-21, and the T^{C18}T^{tBu}T^{H} starting resin were each spin-coated onto silicon wafers and pyrolysed at 450° C. under inert atmosphere and the films were evaluated as described in Example 1. The results are shown in Table 12.

### EXAMPLES 22 to 24

18 g of AnSiCl₃ (trichlorosilymethylanthracene, prepared by reaction of chloromethylanthracene and trichlorosilane in the presence of tri-n-propylamine) (0.055 mol) and 7.49 g of HSiCl₃ (0.055 mol) were mixed into 60 ml MIBK and added dropwise into a mixture of 60 ml H₂O, 60 ml MIBK and 40 ml toluene over 30 minutes at room temperature. The temperature of the reaction mixture rose to 60° C. upon addition. The reaction mixture was refluxed at 110° C. for further 2 hr. The organic layer was separated and washed four times with distilled water until neutral. A first portion (40 ml) of the resulting T^{An}T^{H} resin (which also contained some Q groups) was sampled from the solution.

The rest of the T^{An}T^{H} solution was mixed with 100 ml of 0.5M aqueous sodium acetate at 40° C. Different compositions of T^{An}T^{H}Q were then sampled (40 ml each) out of the organic layer from the solution system at different times as shown in Table 12 below. After washing the samples four times, stripping off the residual water and solvent, approximately 4 to 5 g. of a light brown solid were obtained from each of these portions.

TABLE 12

| | | % of T^{H} | Formula |
|---|---|---|---|
| | Reaction time | conversion | (by ²⁹Si NMR) |
| T^{An}T^{H} resin | 0 hr | | T^{An}_{0.45}T^{H}_{0.40}Q_{0.15} |
| Example 22 | 1 day | 50.0 | T^{An}_{0.45}T^{H}_{0.28}Q_{0.28} |
| Example 23 | 3 days | 61.8 | T^{An}_{0.45}T^{H}_{0.21}Q_{0.34} |
| Example 24 | 6 days | 70.7 | T^{An}_{0.45}T^{H}_{0.16}Q_{0.39} |

These T^{An}T^{H}Q resins were each spin-coated onto silicon wafers and refractive index RI was evaluated by spectroscopic ellipsometry (Rudolph, 633 nm) of two specimens after curing at 150° C. Very high RIs between 1.647 and 1.704 were observed for the resins of Examples 22 to 24, as listed in Table 13, with a RI deviation below 1% for each example.

TABLE 13

| | Compositions | RI |
|---|---|---|
| T^{An}T^{H} resin | T^{An}_{0.45}T^{H}_{0.40}Q_{0.15} | 1.647 |
| Example 22 | T^{An}_{0.45}T^{H}_{0.28}Q_{0.28} | 1.692 |
| Example 23 | T^{An}_{0.45}T^{H}_{0.21}Q_{0.34} | 1.702 |
| Example 24 | T^{An}_{0.45}T^{H}_{0.16}Q_{0.39} | 1.704 |

### EXAMPLES 25 to 27

20.00 g of BzISiCl₃ (2-iodophenylmethyl-trichlorosilane, prepared by reaction of 1-chloromethyl-2-iodo-benzene and trichlorosilane in the presence of tri-n-propylamine)(0.057 mol) and 7.71 g of HSiCl₃ (0.057 mol) were mixed into 40 ml MIBK and added dropwise into a mixture of 60 ml H₂O, 80 ml MIBK and 40 ml Toluene over 30 minutes at room temperature. The temperature of the reaction mixture rose to 60° C. upon addition. The reaction mixture was refluxed at 100° C. for further 2 hr. The organic layer was separated and washed four times with distilled water until neutral. A first portion (40 ml) of the resulting T^{BzI}T^{H} resin (which also contained some Q groups) was sampled from the solution.

The rest of the T^{BzI}T^{H} solution was mixed with 100 ml of 0.5M aqueous sodium acetate at 40° C. Different compositions of T^{BzI}T^{H}Q were then sampled (40 ml each) out of the organic layer from the solution system at different times as shown in Table 14 below. After washing the samples four times, stripping off the residual water and solvent, approximately 4 to 5 g. of a crispy white solid were obtained from each of these portions.

TABLE 14

| | | % of T^{H} | Formula |
|---|---|---|---|
| | Reaction time | conversion | (by ²⁹Si NMR) |
| T^{BzI}T^{H} resin | 0 hr | | T^{BzI}_{0.50}T^{H}_{0.37}Q_{0.13} |
| Example 25 | 6 hr | 40.8 | T^{BzI}_{0.51}T^{H}_{0.29}Q_{0.20} |
| Example 26 | 1 day | 54.0 | T^{BzI}_{0.51}T^{H}_{0.23}Q_{0.27} |
| Example 27 | 6 days | 80.0 | T^{BzI}_{0.50}T^{H}_{0.10}Q_{0.40} |

The T^{BzI}T^{H}Q resins of Examples 25 and 26 were each spin-coated onto silicon wafers and refractive index RI was evaluated by spectroscopic ellipsometry (Rudolph, 633 nm; average of 2 specimens) after curing at 150° C., as shown in Table 15.

TABLE 15

| | Compositions | RI |
|---|---|---|
| T^{BzI}T^{H} resin | T^{BzI}_{0.50}T^{H}_{0.37}Q_{0.13} | 1.625 |
| Example 25 | T^{BzI}_{0.51}T^{H}_{0.29}Q_{0.20} | 1.612 |
| Example 26 | T^{BzI}_{0.51}T^{H}_{0.23}Q_{0.27} | 1.622 |

### EXAMPLES 28 and 29

30.00 g of NapSiCl₃ (naphthalenemethyl-trichlorosilane, prepared by reaction of 1-chloromethylnaphthalene and trichlorosilane in the presence of tri-n-propylamine) (0.109 mol) and 14.72 g of HSiCl₃ (0.109 mol) were mixed into 60 ml MIBK and added dropwise into a mixture of 90 ml H₂O, 120 ml MIBK and 60 ml Toluene over 40 minutes at room temperature. The temperature of the reaction mixture rose to 60° C. upon addition. The reaction mixture was refluxed at 100° C. for further 2 hr. The organic layer was separated and washed four times with distilled water until neutral. A first portion (100 ml) of the resulting T^{Nap}T^{H} resin (which also contained some Q groups) was sampled from the solution.

The rest of the T^{Nap}T^{H} solution was mixed with 100 ml of 0.5M aqueous sodium acetate at 25° C. Different compositions of T^{Nap}T^{H}Q were then sampled (70 ml each) out of the organic layer from the solution system at two different times as shown in Table 16 below. After washing the samples four times, stripping off the residual water and solvent, approximately 7.5 and 8.0 g of light yellow solid were obtained from each of these portions.

TABLE 16

| | | % of T^{H} | Formula |
|---|---|---|---|
| | Reaction time | conversion | (by ²⁹Si NMR) |
| T^{Nap}T^{H} resin | 0 hr | | T^{Nap}_{0.49}T^{H}_{0.30}Q_{0.20} |
| Example 28 | 1 day | 44.0 | T^{Nap}_{0.50}T^{H}_{0.28}Q_{0.22} |
| Example 29 | 7 day | 56.9 | T^{Nap}_{0.49}T^{H}_{0.22}Q_{0.29} |

These T^{Nap}T^{H}Q resins were each spin-coated onto silicon wafers and refractive index RI was evaluated by spectroscopic ellipsometry (Rudolph, 633 nm; average of two specimens) after curing at 150° C. The results are listed in Table 17.

TABLE 17

| | Compositions | RI |
|---|---|---|
| T^{Nap}T^{H} resin | T^{Nap}_{0.49}T^{H}_{0.30}Q_{0.20} | 1.608 |
| Example 28 | T^{Nap}_{0.50}T^{H}_{0.28}Q_{0.22} | 1.586 |
| Example 29 | T^{Nap}_{0.49}T^{H}_{0.22}Q_{0.29} | 1.581 |

### EXAMPLE 30

Preparation of M^{ViMe2}_{0.28}T^{Ph}_{0.24}T^{H}_{0.13}Q_{0.35} Resin.

60.00 g (284 mmol) of phenyltrichlorosilane, 88.78 g (655 mmol) of trichlorosilane and 47.52 g (394 mmol) of dimethylvinylchlorosilane were dissolved into 240 ml of MIBK, then added dropwise into a mixture consisting of 240 ml of a 1M HCl aqueous solution, 360 ml toluene and 480 ml MIBK at room temperature over a 1 h period. The mixture was refluxed at 110° C. for another 3 hours under constant stirring. The organic layer was collected and washed four times with water until neutral pH. 240 ml of a 1M sodium acetate aqueous solution was added and the mixture was heated at 80 to 90° C. for a further 3 days under constant stirring. The organic layer was collected and washed four times with water. Removal of residual water by anhydrous NaSO₄, and stripping off the solvent led to 93 g of soft solid being highly soluble in common organic solvents. The M^{ViMe2}_{0.24}T^{Ph}_{0.25}T^{H}_{0.13}Q_{0.38} composition of this resin was determined by ²⁹Si and ¹³C NMR spectroscopy. To this solid, re-dissolved into 100 ml of anhydrous toluene, was added at room temperature and under stirring 6.6 g (54.8 mmol) of dimethylvinylchlorosilane and 10.1 g (54.7 mmol) of 1,3-divinyl-1,1,3,3-tetramethyldisilazane. The mixture was heated from 40 to 60° C. for 2 hours. The organic layer was collected and washed four times with water until neutral pH. The mixture was treated by anhydrous MgSO₄ to remove residual water and the volatiles were stripped off leading to 88 g of a soft solid. The M^{ViMe2}_{0.28}T^{Ph}_{0.24}T^{H}_{0.13}Q_{0.35} resin composition of this resin was determined by ²⁹Si and ¹³C NMR spectroscopy (Mn=2,022; Mw=7,276, OH wt % <0.3%).

Cure of M^{ViMe2}_{0.28}T^{Ph}_{0.24}T^{H}_{0.13}Q_{0.35} with M^{H}D₄M^{H}.

To 4.0 g of a 86.4 wt % solution of M^{ViMe2}_{0.28}T^{Ph}_{0.24}T^{H}_{0.13}Q_{0.35} resin (example 2) in toluene, was added under stirring 2.0 g of M^{H}D₄M^{H} and 0.3 g of a 10 wt % solution of a platinum (0)-1,3-divinyl-1,1,3,3-tetramethyldisiloxane complex in toluene (Pt°/SiH=50 ppm). The mixture was poured into a mould for gradual heating up to 200° C. for 3 h. The final material was analysed by dynamic mechanical thermal analysis (DMTA) and thermomechanical analysis (TMA) (Table 18), in which E′₂₅ is the modulus at 25° C. or Young's modulus and E′ₚ is the plateau modulus.

Cure of M^{ViMe2}_{0.28}T^{Ph}_{0.24}T^{H}_{0.13}Q_{0.35} with 1,4-bis(dimethylsilyl)benzene.

To 4.0 g of a 86.4 wt % solution of M^{ViMe2}_{0.28}T^{Ph}_{0.24}T^{H}_{0.13}Q_{0.35} resin (example 2) in toluene, was added under stirring 0.9 g of 1,4-bis(dimethylsilyl)benzene and 0.3 g of a 10 wt % solution of a platinum (0)-1,3-divinyl-1,1,3,3-tetramethyldisiloxane complex in toluene (Pt°/SiH=50 ppm). The mixture was poured into a mould for gradual heating up to 200° C. for 3 h. The final material was analysed by DMTA and TMA (Table 18).

Cure of M^{ViMe2}_{0.28}T^{Ph}_{0.24}T^{H}_{0.13}Q_{0.35} with M^{H}₃T^{Ph}.

To 4.0 g of a 86.4 wt % solution of M^{ViMe2}_{0.28}T^{Ph}_{0.24}T^{H}_{0.13}Q_{0.35} resin (example 2) in toluene, was added under stirring 1.0 g of M^{H}₃T^{Ph} and 0.3 g of a 10 wt % solution of a platinum (0)-1,3-divinyl-1,1,3,3-tetramethyldisiloxane complex in toluene (Pt°/SiH=50 ppm). The mixture was poured into a mould for gradual heating up to 200° C. for 3 h. The final material was analysed by DMTA and TMA (Table 18).

Cure of M^{ViMe2}_{0.28}T^{Ph}_{0.24}T^{H}_{0.13}Q_{0.35} with D^{H,Me}₄.

To 4.0 g of a 86.4 wt % solution of M^{ViMe2}_{0.28}T^{Ph}_{0.24}T^{H}_{0.13}Q_{0.35} resin (example 2) in toluene, was added under stirring 0.6 g of D^{H,Me}₄ and 0.3 g of a 10 wt % solution of a platinum (0)-1,3-divinyl-1,1,3,3-tetramethyldisiloxane complex in toluene (Pt°/SiH=50 ppm). The mixture was poured into a mould for gradual heating up to 200° C. for 3 h. The final material was analysed by DMTA and TMA (Table 18).

Cure of M^{ViMe2}_{0.28}T^{Ph}_{0.24}T^{H}_{0.13}Q_{0.35} with M^{H}₈Q₈.

To 4.0 g of a 86.4 wt % solution of M^{ViMe2}_{0.28}T^{Ph}_{0.24}T^{H}_{0.13}Q_{0.35} resin (example 2) in toluene, was added under stirring 1.2 g of M^{H}₈Q₈, 0.3 g of a 10 wt % solution of a platinum (0)-1,3-divinyl-1,1,3,3-tetramethyldisiloxane complex in toluene (Pt°/SiH=50 ppm) and 4.0 g of anhydrous toluene. The mixture was poured into a mould for gradual heating up to 200° C. for 3 h. The final material was analysed by DMTA and TMA (Table 18).

TABLE 18

| Curing Agent | E′₂₅ (MPa) | E′ₚ (MPa) |
|---|---|---|
| M^{H}D₄M^{H} | 440 | 420 |
| (HMe₂Si)₂Ph | 2,430 | 660 |
| M^{H}₃T^{Ph} | 1,410 | 890 |
| D^{H, Me}₄ | 1,270 | 1,010 |
| M^{H}₈Q₈ | 1,850 | 1,620 |

### EXAMPLE 31

Preparation of M^{ViMe2}_{0.2}T^{Ph}_{0.48}T^{H}_{0.12}Q_{0.20} Resin.

41.15 g (196 mmol) of phenyltrichlorosilane, 23.18 g (171 mmol) of trichlorosilane and 14.74 g (122 mmol) of dimethylvinylchlorosilane were dissolved into 135 ml of MIBK, then added dropwise into a mixture consisting of 135 ml of a 1M HCl aqueous solution, 135 ml toluene and 270 ml MIBK at room temperature over a period of 45 minutes. The mixture was refluxed at 110° C. for another 3 hours under constant stirring. The organic layer was isolated and washed four times with water until neutral pH. 300 ml of a 1M sodium acetate aqueous solution was added into the organic layer and the mixture was heated at 40° C. over 6 days under constant stirring. The organic layer was isolated again and washed four times with water until neutral pH. Removal of residual water by anhydrous NaSO₄, and stripping off the solvent led to 67.8 g of a light yellow soft solid being highly soluble in common organic solvents. The M^{ViMe2}_{0.20}T^{Ph}_{0.48}T^{H}_{0.12}Q_{0.20} composition of this resin was determined by ²⁹Si and ¹³C NMR spectroscopy (Mn=1,490; Mw=2,765).

### EXAMPLE 32

Preparation of M^{ViMe2}_{0.22}T^{Ph}_{0.27}T^{H}_{0.15}Q_{0.36} Resin.

To a toluene/MIBK mixture of M^{ViMe2}_{0.23}T^{Ph}_{0.26}T^{H}_{0.42}Q_{0.09} prepared according to example 3, was added 360 ml of a 1M sodium acetate solution. The mixture was heated at 90° C. for 16 hr under constant stirring. The organic layer was isolated and washed four times with water until neutral pH. Removal of residual water by anhydrous NaSO₄, and stripping off the solvent led to 95 g of a soft liquid, being highly soluble in common organic solvents. The M^{ViMe}²_{0.22}T^{Ph}_{0.27}T^{H}_{0.15}Q_{0.36} composition of this resin was determined by ²⁹Si and ¹³C NMR spectroscopy. (Mn=2,125; Mw=6,299).

Self-Addition Cure of M^{ViMe2}ᵥM^{HMe2}_{w}T^{Ph}ₓT^{H}_{y}Q_{z} Resins.

The self-addition curable silicone resins produced in Examples 31 and 32 were subjected to addition cure using a platinum (0)-1,3-divinyl-1,1,3,3-tetramethyldisiloxane complex in toluene as the catalyst. Each resin was dissolved in anhydrous toluene and then mixed with a catalytic amount of a platinum (0)-1,3-divinyl-1,1,3,3-tetramethyldisiloxane complex in toluene (Pt°/SiH=50 ppm) for 10 minutes to a 75 wt % solution before casting into a mould. The samples were then heated gradually up to 150 or 200° C. for 3 h. Large pieces of crack-free specimen were obtained for analysis by DMTA and TMA (Table 19).

TABLE 19

| Curable Silicone Resin | Cure Temp. | E′₂₅ (MPa) | E′ₚ (MPa) |
|---|---|---|---|
| Example 31 | 200° C. | 1,475 | 727 |
| Example 32 | 150° C. | 1,018 | 554 |
| Example 32 | 200° C. | 2,060 | 1,600 |

1. A process for the preparation of a solution of a stable silicone resin, said silicone resin comprising SiO_{4/2} units and units selected from the group consisting of RSiO_{3/2}, RR′SiO_{2/2}, and RR′2SiO_{1/2} units, wherein R is selected from the group consisting of alkyl group, alkenyl group, substituted alkyl group, cycloalkyl group, aryl group and aralkyl group, and each R′ is independently selected from the group consisting of alkyl group, substituted alkyl group, cycloalkyl group, aryl group, aralkyl group, and a hydrogen atom, said process comprising the steps of:
(I) preparing a hydrosiloxane resin comprising HSiO_{3/2} units and said units selected from RSiO_{3/2}, RR′SiO_{2/2}, and RR′₂SiO_{1/2} units,
(II) treating said hydrosiloxane resin with a base to condense at least some of the HSiO_{3/2} units to form SiO_{4/2} units,
thereby preparing said silicone resin.

2 A process according to claim 1 wherein said hydrosiloxane resin comprises 15-85 mole % RSiO_{3/2} units and 20-80 mole % HSiO_{3/2} units.

3. A process according to claim 1 wherein said base is a solution of an alkali metal salt of a weak acid in a solvent mixture of water and a dipolar aprotic solvent which is at least partially miscible with water.

4. A process according to claim 3 wherein said alkali metal salt of a weak acid is sodium acetate.

5. A process according to claim 3 wherein said dipolar aprotic solvent is a ketone having 4 to 7 carbon atoms.

6. A process according to claim 1 wherein said base comprises an amine.

7. A process according to claim 6 wherein said base comprises a solution of an alkali metal salt of a weak acid in a solvent mixture of water and a tertiary amine.

8. A process according to claim 1 wherein the strength and concentration of said base and the time and temperature of treatment are sufficient to condense at least 30% of the HSiO3/2 units to SiO4/2 units.

9. A process according to claim 1 wherein R is a thermally labile group.

10. A process according to claim 9 wherein R is a branched alkyl group.

11. A process according to claim 10 wherein R is t-butyl.

12. A process according to claim 10 wherein R is 2-(2,2-dimethylpropyl)-4,4-dimethylpentyl.

13. A process according to claim 9 wherein R is selected from the group consisting of a hydrocarbon group comprising 8 to 24 carbon atoms and a substituted hydrocarbon group comprising a hydrocarbon chain having 8 to 24 carbon atoms.

14. A process according to claim 9 wherein said hydrosiloxane resin comprises units in which R is a branched alkyl group and units wherein R is selected from the group consisting of a hydrocarbon group comprising 8 to 24 carbon atoms, and a substituted hydrocarbon group comprising a hydrocarbon chain having 8 to 24 carbon atoms.

15. A silicone resin prepared by the process of claim 9.

16. A method for making a nanoporous silicone resin coating on a substrate comprising the steps of:
(I) preparing a silicone resin in accordance with claim 15
(II) coating said silicone resin on a substrate, and
(III) heating said substrate at a temperature sufficient to effect curing of said silicone resin and thermolysis of said R groups from silicon atoms, thereby forming a nanoporous silicone resin coating on the substrate.

17. A nanoporous silicone resin prepared by the method of claim 16 having a dielectric constant DK of 1.5 to 2.5 at 1 MHz and a modulus of 1 to 8 GPa.
